(19) United States
(12) Patent Application Publication
(10) Pub. No.: US 2023/0139152 A1
(43) Pub. Date: May 4, 2023

(54) BUILDING SYSTEM WITH BUILDING IMPROVEMENT TARGETING FOR BUILDINGS

(71) Applicant: Johnson Controls Tyco IP Holdings LLP, Milwaukee, WI (US)

(72) Inventors: Tyler A. Smith, Franklin, TN (US); Jonathan D. Douglas, Mequon, WI (US); Kirk H. Drees, Cedarburg, WI (US); Neuman Leverett, Milwaukee, WI (US); Brian Estill, Milwaukee, WI (US)

(21) Appl. No.: 17/972,454

(22) Filed: Oct. 24, 2022

Related U.S. Application Data
(60) Provisional application No. 63/274,138, filed on Nov. 1, 2021.

(51) Int. Cl. F24F 11/49; F24F 11/56

(52) U.S. Cl. CPC F24F 11/49; F24F 11/56

(57) ABSTRACT

A system can operate to receive building data for a plurality of buildings from one or more data sources. At least one building of the buildings can include building equipment. The system can operate to generate scores based on the building data for the buildings, the scores can indicate a level of potential building improvements for the buildings. The system can operate to select the building of the buildings based at least in part on the scores. The system can operate to perform an operation based at least in part on the score to generate data to improve control of the environmental condition of the building.

### CROSS-REFERENCE TO RELATED PATENT APPLICATION

This application claims the benefit of, and priority to, U.S. Provisional Pat. Application No. 63/274,138 filed November 1^{st}, 2021, the entirety of which is incorporated by reference herein.

### BACKGROUND

The present application relates to identifying building improvements for a building. Service providers can offer a variety of building improvements for a building, e.g., installing solar panels on a building, retrofitting an older building with new equipment, implementing control algorithms that save energy or reduce carbon emissions, etc. However, it is often difficult for the service provider to properly identify what buildings would benefit from building improvements. Furthermore, for a geographic area that the service provider services, it may be difficult for the service provider to understand which buildings of a large group of buildings would benefit from the building improvements.

### SUMMARY

One implementation of the present disclosure is a system that can include one or more memory devices storing instructions thereon that, when executed by one or more processors, cause the one or more processors to receive building data for buildings from one or more data sources, wherein at least one building of the buildings includes building equipment that operates to execute a control algorithm to control an environmental condition of the building. The system can operate to generate scores based on the building data for the buildings, the scores indicating a level of potential building improvements for the buildings. The system can operate to select the building of the buildings based at least in part on the scores. The system can operate to perform an operation based at least in part on the score to generate data to improve control of the environmental condition of the building.

In some embodiments, the instructions cause the one or more processors to perform the operation to deploy at least one of operating settings to the building equipment of the building to cause the control algorithm to control the environmental condition of the building based on the operating setting.

In some embodiments, the one or data sources include one or more third party databases managed by an entity other than an entity associated with the building.

In some embodiments, the instructions cause the one or more processors to perform the operation by generating a work order for implementing the building improvement for the building.

In some embodiments, the building data is public data describing the buildings or describing conditions associated with the buildings.

In some embodiments, the building data includes image data of the buildings captured by at least one satellite. In some embodiments, the instructions cause the one or more processors to derive one or more factors describing the buildings from the image data.

In some embodiments, the building data is sensor data collected from temporary sensors installed in the buildings at a time and uninstalled from the buildings after a period of time passes from the time.

In some embodiments, the instructions cause the one or more processors to generate the scores based on the building data and scoring rules, receive feedback data indicating one or more first building improvements approved by an entity of the building and one or more second building improvements rejected by the entity, and perform a machine learning algorithm on the feedback data to identify one or more updates for the scoring rules.

In some embodiments, the instructions cause the one more processors to generate a user interface including the scores, indications of the buildings, and indications of potential building improvements for the buildings and cause a display device of a user device to display the user interface.

In some embodiments, the instructions cause the one or more processors to generate data to cause a user device to display a user interface to include a map of a geographic area including the buildings. In some embodiments, the user interface includes an indication for the buildings in the map of the geographic area indicating the score for the buildings.

In some embodiments, the instructions can cause the one or more processors to generate the score of the scores for the building of the buildings by generating sub-scores of categories based on the building data and aggregating the sub-scores into the score.

In some embodiments, the sub-scores are based on data elements including an air quality index (AQI) indicating an air quality in a geographic area of the building, indications of building equipment installed in the building, a solar intensity associated with the building, a square footage of the building, a year that the building was built, an indication of work permits implemented at a second building owned by a competitor of the building, an indication of one or more certifications of the building, or an indication of an availability of stimulus funding for the building.

One implementation of the present disclosure is a method including receiving, by one or more processing circuits, building data for buildings from one or more data sources, wherein at least one building of the buildings includes building equipment that operates to execute a control algorithm to control an environmental condition of the building. The method can include generating, by the one or more processing circuits, scores based on the building data for the buildings, the scores indicating a level of potential building improvements for the buildings. The method can include selecting, by the one or more processing circuits, the building of the buildings based at least in part on the scores. The method can include performing, by the one or more processing circuits, an operation to generate data to improve control of the environmental condition of the building.

In some embodiments, the method includes performing, by the one or more processing circuits, the operation to deploy at least one of operating settings to the building equipment of the building to cause the control algorithm to control the environmental condition of the building based on the operating setting.

In some embodiments, the building data includes image data of the buildings captured by at least one satellite. In some embodiments, the method includes deriving, by the one or more processing circuits, one or more factors describing the buildings from the image data.

In some embodiments, the building data is sensor data collected from temporary sensors installed in the buildings at a time and uninstalled from the buildings after a period of time passes from the time.

In some embodiments, the method includes generating, by the one or more processing circuits, the scores based on the building data and scoring rules. In some embodiments, the method includes receiving, by the one or more processing circuits, feedback data indicating one or more first building improvements approved by an entity of the building and one or more second building improvements rejected by the entity. In some embodiments, the method includes performing, by the one or more processing circuits, a machine learning algorithm on the feedback data to identify one or more updates for the scoring rules.

In some embodiments, the method includes generating, by the one or more processing circuits, a user interface including the scores, indications of the buildings, and indications of potential building improvements for the buildings and causing, by the one or more processing circuits, a display device of a user device to display the user interface.

Another implementation of the present disclosure is one or more computer readable medium storing instructions thereon that, when executed by one or more processors, cause the one or more processors to receive building data for buildings from one or more data sources, wherein at least one building of the buildings includes building equipment that operates to execute a control algorithm to control an environmental condition of the building. The instructions can cause the one or more processors to generate scores based on the building data for the buildings, the scores indicating a level of potential building improvements for the buildings. The instructions can cause the one or more processors to select the building of the buildings based at least in part on the scores. The instructions can cause the one or more processors to perform an operation based at least in part on the score to generate data to improve control of the environmental condition of the building.

In some embodiments, the instructions cause the one or more processors to perform the operation to deploy at least one of operating settings to the building equipment of the building to cause the control algorithm to control the environmental condition of the building based on the operating setting.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to an exemplary embodiment.

FIG. 2 is a block diagram of a building automation system (BAS) that may be used to monitor and/or control the building of FIG. 1, according to an exemplary embodiment.

FIG. 3 is a block diagram of a building target identifier configured to receive data related to a building and generate a targeting score indicating a potential for implementing building improvements, according to an exemplary embodiment.

FIG. 4 is a schematic diagram of a user interface of a city including building targeting scores for buildings of the city, according to an exemplary embodiment.

FIG. 5 is a flow diagram of a process of generate targeting scores indicating potentials for implementing building improvements for various buildings, according to an exemplary embodiment.

### DETAILED DESCRIPTION

Referring generally to the FIGURES, systems and methods for building improvement targeting for buildings is shown, according to various exemplary embodiments. The building system described herein can be configured to perform improvement targeting for buildings. The building system can be configured analyze data of buildings to identify which buildings should be targeted for building improvements. In some embodiments, the various improvements may be installing new building equipment, retrofitting existing building equipment, changing the physical construction of buildings, performing maintenance on existing building equipment, implementing new control algorithms, adjusting control settings for the building equipment, etc. The building system can be configured to analyze data describing the various buildings and identify which buildings have the greatest potential for building improvements.

In some embodiments, the building system can analyze publically available data for a building to identify the potential for recommending building improvements to owners or managers of the building. For example, some buildings may have the potential for a large service job, e.g., a large square footage on top of a building might mean that many solar panels could be installed on the roof of the building. Such factors can be identified by the building system and used to determine which buildings in a geographic area should be targeted with recommendations for improvement.

In some cases, the factors can indicate a potential amount of performance improvements that may be made via building improvements. For example, in some implementations, the system may determine buildings for which available data indicates the possibility of significant improvements (e.g., improvements above a certain level) to health, safety, sustainability, etc. of the building by way of certain improvements. In some cases, the factors can indicate the level of financial return resulting from the building improvement to the service provider for performing the building improvement, e.g., total amount of money that the service provider would be paid for implementing the building improvement. In some cases, the factors can indicate the level of financial return resulting from the building improvement to the owner or operator of the building, e.g., energy savings of the building. In some cases, the recommendations are sales recommendations, e.g., a proposal for a building improvement.

In some embodiments, the building system can be configured to generate targeting scores for a group of buildings. The targeting scores can indicate the potential for building improvements for each of the buildings, e.g., each building may have its own targeting score generated by the building system. The targeting scores can be generated from publically available data. In some embodiments, the building system receives publically available data, e.g., data from certification systems, data from satellite imaging systems, data from weather information systems, data from government agencies indicating building work permits, etc. While various implementations discuss scores on an individual building basis, it should be understood that, in some embodiments, scores may be generated for groups of buildings/campuses. In some embodiments, scores may be generated for portions of buildings rather than whole buildings. All such modifications are contemplated within the scope of the present disclosure.

In some embodiments, the building system can be configured to select one or multiple buildings that have a high targeting score, e.g., a number of the highest targeting scores, targeting scores over a level, etc. The building system can generate one or more recommendations for each specific building describing the various equipment installations, building construction improvements, retrofits, control algorithm or control setting implementations, etc. that could be implemented to improve the operation of the buildings. The recommendation can indicate a financial return for the improvements, a carbon emissions reduction resulting from the improvements, a sustainability indication resulting from the improvements, etc. Responsive to receiving approval from an owner or manager of the building, the building system can cause the building improvements to be implemented, e.g., generate work orders for technicians and installers, implement control settings and/or algorithms for the building, etc.

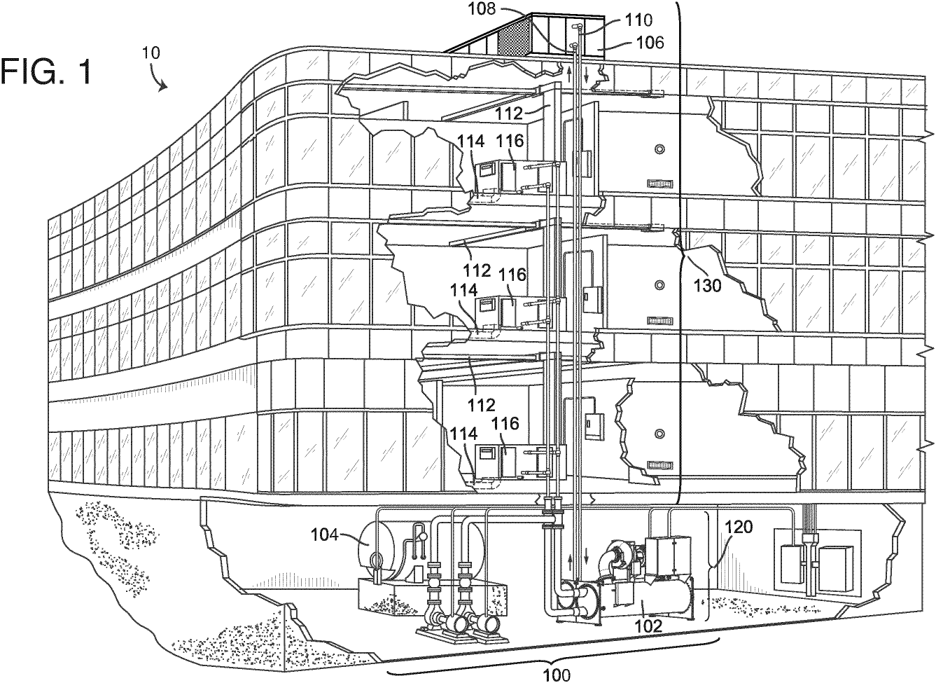

Referring now to FIG. 1, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

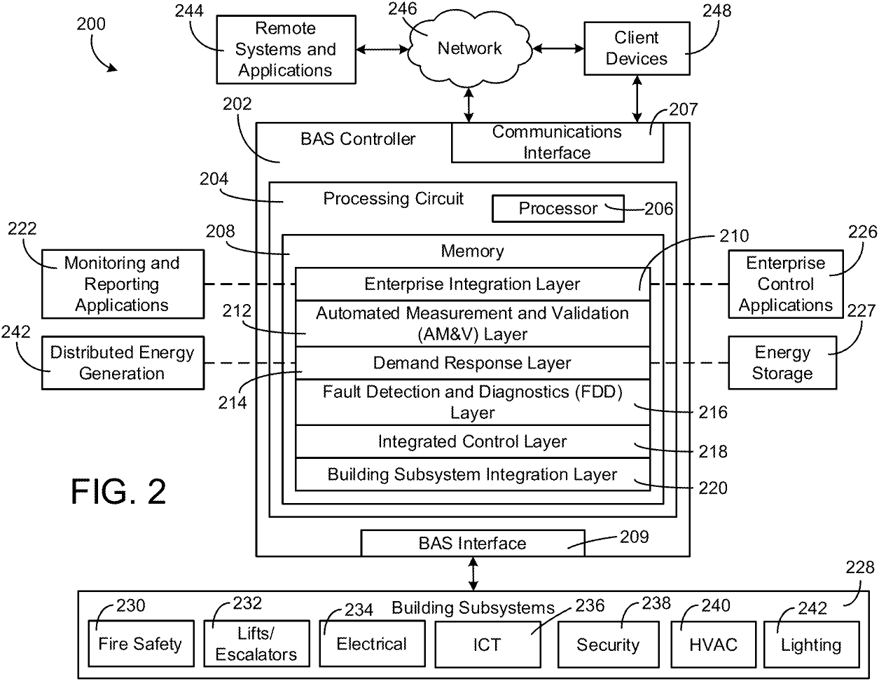

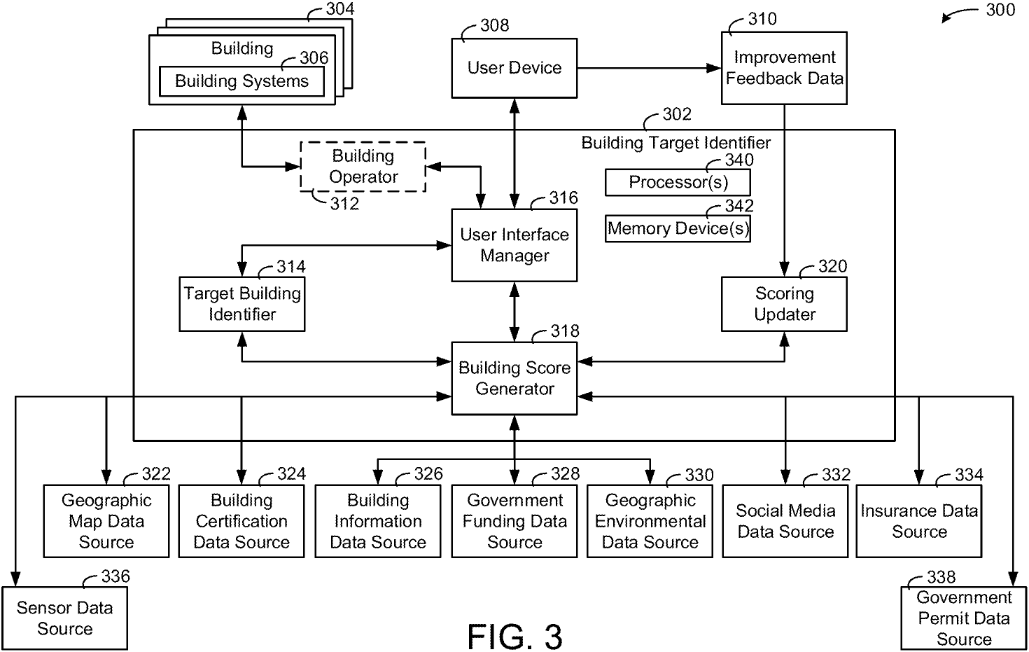

The BMS that serves building 10 includes an HVAC system 100. HVAC system 100 can include HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a building automation system (BAS) 200 is shown, according to an exemplary embodiment. BAS 200 can be implemented in building 10 to automatically monitor and control various building functions. BAS 200 is shown to include BAS controller 202 and building subsystems 228. Building subsystems 228 are shown to include a building electrical subsystem 234, an information communication technology (ICT) subsystem 236, a security subsystem 238, a HVAC subsystem 240, a lighting subsystem 242, a lift/escalators subsystem 232, and a fire safety subsystem 230. In various embodiments, building subsystems 228 can include fewer, additional, or alternative subsystems. For example, building subsystems 228 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 228 include a waterside system and/or an airside system. A waterside system and an airside system are described with further reference to U.S. Pat. Application No. 15/631,830 filed Jun. 23, 2017, the entirety of which is incorporated by reference herein.

Each of building subsystems 228 can include any number of devices, controllers, and connections for completing its individual functions and control activities. HVAC subsystem 240 can include many of the same components as HVAC system 100, as described with reference to FIG. 1. For example, HVAC subsystem 240 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 242 can include any number of light fixtures, ballasts, lighting sensors, dimmers, or other devices configured to controllably adjust the amount of light provided to a building space. Security subsystem 238 can include occupancy sensors, video surveillance cameras, digital video recorders, video processing servers, intrusion detection devices, access control devices and servers, or other security-related devices.

Still referring to FIG. 2, BAS controller 266 is shown to include a communications interface 207 and a BAS interface 209. Interface 207 can facilitate communications between BAS controller 202 and external applications (e.g., monitoring and reporting applications 222, enterprise control applications 226, remote systems and applications 244, applications residing on client devices 248, etc.) for allowing user control, monitoring, and adjustment to BAS controller 266 and/or subsystems 228. Interface 207 can also facilitate communications between BAS controller 202 and client devices 248. BAS interface 209 can facilitate communications between BAS controller 202 and building subsystems 228 (e.g., HVAC, lighting security, lifts, power distribution, business, etc.).

Interfaces 207, 209 can be or include wired or wireless communications interfaces (e.g., jacks, antennas, transmitters, receivers, transceivers, wire terminals, etc.) for conducting data communications with building subsystems 228 or other external systems or devices. In various embodiments, communications via interfaces 207, 209 can be direct (e.g., local wired or wireless communications) or via a communications network 246 (e.g., a WAN, the Internet, a cellular network, etc.). For example, interfaces 207, 209 can include an Ethernet card and port for sending and receiving data via an Ethernet-based communications link or network. In another example, interfaces 207, 209 can include a Wi-Fi transceiver for communicating via a wireless communications network. In another example, one or both of interfaces 207, 209 can include cellular or mobile phone communications transceivers. In some embodiments, communications interface 207 is a power line communications interface and BAS interface 209 is an Ethernet interface. In other embodiments, both communications interface 207 and BAS interface 209 are Ethernet interfaces or are the same Ethernet interface.

Still referring to FIG. 2, BAS controller 202 is shown to include a processing circuit 204 including a processor 206 and memory 208. Processing circuit 204 can be communicably connected to BAS interface 209 and/or communications interface 207 such that processing circuit 204 and the various components thereof can send and receive data via interfaces 207, 209. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to an exemplary embodiment, memory 208 is communicably connected to processor 206 via processing circuit 402 and includes computer code for executing (e.g., by processing circuit 204 and/or processor 206) one or more processes described herein.

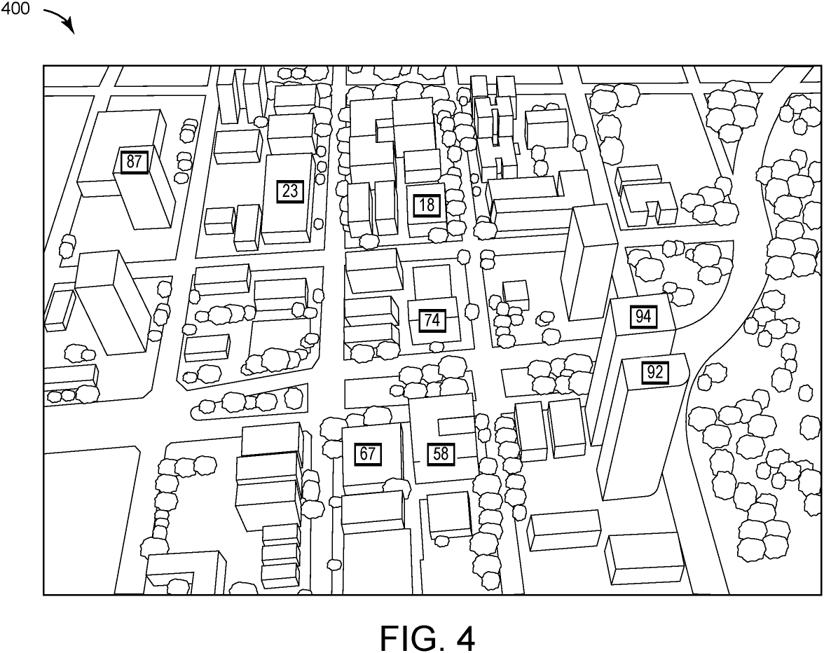

In some embodiments, BAS controller 202 is implemented within a single computer (e.g., one server, one housing, etc.). In various other embodiments BAS controller 202 can be distributed across multiple servers or computers (e.g., that can exist in distributed locations). Further, while FIG. 4 shows applications 222 and 226 as existing outside of BAS controller 202, in some embodiments, applications 222 and 226 can be hosted within BAS controller 202 (e.g., within memory 208).

Still referring to FIG. 2, memory 208 is shown to include an enterprise integration layer 210, an automated measurement and validation (AM&V) layer 212, a demand response (DR) layer 214, a fault detection and diagnostics (FDD) layer 216, an integrated control layer 218, and a building subsystem integration later 220. Layers 210-220 can be configured to receive inputs from building subsystems 228 and other data sources, determine optimal control actions for building subsystems 228 based on the inputs, generate control signals based on the optimal control actions, and provide the generated control signals to building subsystems 228. The following paragraphs describe some of the general functions performed by each of layers 210-220 in BAS 200.

Enterprise integration layer 210 can be configured to serve clients or local applications with information and services to support a variety of enterprise-level applications. For example, enterprise control applications 226 can be configured to provide subsystem-spanning control to a graphical user interface (GUI) or to any number of enterprise-level business applications (e.g., accounting systems, user identification systems, etc.). Enterprise control applications 226 can also or alternatively be configured to provide configuration GUIs for configuring BAS controller 202. In yet other embodiments, enterprise control applications 226 can work with layers 210-220 to optimize building performance (e.g., efficiency, energy use, comfort, or safety) based on inputs received at interface 207 and/or BAS interface 209.

Building subsystem integration layer 220 can be configured to manage communications between BAS controller 202 and building subsystems 228. For example, building subsystem integration layer 220 can receive sensor data and input signals from building subsystems 228 and provide output data and control signals to building subsystems 228. Building subsystem integration layer 220 can also be configured to manage communications between building subsystems 228. Building subsystem integration layer 220 translates communications (e.g., sensor data, input signals, output signals, etc.) across multi-vendor/multi-protocol systems.

Demand response layer 214 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 224, from energy storage 227, or from other sources. Demand response layer 214 can receive inputs from other layers of BAS controller 202 (e.g., building subsystem integration layer 220, integrated control layer 218, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 214 includes control logic for responding to the data and signals it receives. These responses can include communicating with the control algorithms in integrated control layer 218, changing control strategies, changing setpoints, or activating/deactivating building equipment or subsystems in a controlled manner. Demand response layer 214 can also include control logic configured to determine when to utilize stored energy. For example, demand response layer 214 can determine to begin using energy from energy storage 227 just prior to the beginning of a peak use hour.

In some embodiments, demand response layer 214 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 214 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 214 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user’s application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 218 can be configured to use the data input or output of building subsystem integration layer 220 and/or demand response later 214 to make control decisions. Due to the subsystem integration provided by building subsystem integration layer 220, integrated control layer 218 can integrate control activities of the subsystems 228 such that the subsystems 228 behave as a single integrated supersystem. In an exemplary embodiment, integrated control layer 218 includes control logic that uses inputs and outputs from building subsystems to provide greater comfort and energy savings relative to the comfort and energy savings that separate subsystems could provide alone. For example, integrated control layer 218 can be configured to use an input from a first subsystem to make an energy-saving control decision for a second subsystem. Results of these decisions can be communicated back to building subsystem integration layer 220.

Integrated control layer 218 is shown to be logically below demand response layer 214. Integrated control layer 218 can be configured to enhance the effectiveness of demand response layer 214 by enabling building subsystems 228 and their respective control loops to be controlled in coordination with demand response layer 214. This configuration can reduce disruptive demand response behavior relative to conventional systems. For example, integrated control layer 218 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 218 can be configured to provide feedback to demand response layer 214 so that demand response layer 214 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 218 is also logically below fault detection and diagnostics layer 216 and automated measurement and validation layer 212. Integrated control layer 218 can be configured to provide calculated inputs (e.g., aggregations) to these higher levels based on outputs from more than one building subsystem.

Automated measurement and validation (AM&V) layer 212 can be configured to verify that control strategies commanded by integrated control layer 218 or demand response layer 214 are working properly (e.g., using data aggregated by AM&V layer 212, integrated control layer 218, building subsystem integration layer 220, FDD layer 216, or otherwise). The calculations made by AM&V layer 212 can be based on building system energy models and/or equipment models for individual BAS devices or subsystems. For example, AM&V layer 212 can compare a model-predicted output with an actual output from building subsystems 228 to determine an accuracy of the model.

Fault detection and diagnostics (FDD) layer 216 can be configured to provide on-going fault detection for building subsystems 228, building subsystem devices (i.e., building equipment), and control algorithms used by demand response layer 214 and integrated control layer 218. FDD layer 216 can receive data inputs from integrated control layer 218, directly from one or more building subsystems or devices, or from another data source. FDD layer 216 can automatically diagnose and respond to detected faults. The responses to detected or diagnosed faults can include providing an alarm message to a user, a maintenance scheduling system, or a control algorithm configured to attempt to repair the fault or to work-around the fault.

FDD layer 216 can be configured to output a specific identification of the faulty component or cause of the fault (e.g., loose damper linkage) using detailed subsystem inputs available at building subsystem integration layer 220. In other exemplary embodiments, FDD layer 216 is configured to provide “fault” events to integrated control layer 218 which executes control strategies and policies in response to the received fault events. According to an exemplary embodiment, FDD layer 216 (or a policy executed by an integrated control engine or business rules engine) can shut-down systems or direct control activities around faulty devices or systems to reduce energy waste, extend equipment life, or assure proper control response.

FDD layer 216 can be configured to store or access a variety of different system data stores (or data points for live data). FDD layer 216 can use some content of the data stores to identify faults at the equipment level (e.g., specific chiller, specific AHU, specific terminal unit, etc.) and other content to identify faults at component or subsystem levels. For example, building subsystems 228 can generate temporal (i.e., time-series) data indicating the performance of BAS 200 and the various components thereof. The data generated by building subsystems 228 can include measured or calculated values that exhibit statistical characteristics and provide information about how the corresponding system or process (e.g., a temperature control process, a flow control process, etc.) is performing in terms of error from its setpoint. These processes can be examined by FDD layer 216 to expose when the system begins to degrade in performance and alarm a user to repair the fault before it becomes more severe.

Referring now to FIG. 3, a system 300 including a building target identifier 302 configured to receive data related to a building and generate a targeting score indicating a potential for implementing building improvements is shown, according to an exemplary embodiment. The target identifier 302 can be a system, building system, apparatus, device, cloud computing system, sever system, data processing system, or any other kind of computing system. The data received by the building target identifier 302 can be received from various data sources, e.g., the data sources 322-338. In some embodiments, the data is public data. The public data can be data for a building that is publically available outside the building. The public data can be collected through purchasing the information from a data source, deriving data from public information, receiving free data from a data source, requesting public records from a government entity, etc. In some embodiments, the data is private data. For example, an entity of a building may release, sell, and/or otherwise send private data of a building to the building target identifier 302. The entities that manage the data of the data sources 322-338 may be different than the entity of the building. For example, a company, owner, or user associated with the data sources 322-338 may be different or separate from the company, owner, or user associated with the buildings 304.

In some embodiments, the scores generated by the building target identifier 302 can generate scores for the buildings 304. The buildings 304 can be commercial buildings, offices, apartments, hotels, schools, banks, hospitals, government buildings, etc. The buildings 304 can be the same as, or similar to, the building 10. Each of the buildings 304 can include building systems 306 that control environmental conditions (e.g., temperature, light, humidity, air flow, water temperature, etc.) of the buildings 304, e.g., the various building systems described in FIGS. 1-2. In some embodiments, the systems 306 are fire response systems, access control systems, surveillance systems, security systems, etc. In some embodiments, the building target identifier 302 can generate scores for each building 304, property, and/or tenant.

The scores generated by the building target identifier 302 can be provided to the user device 308. The user device 308 can be a smartphone, a laptop, a desktop computer, a tablet, a console, etc. The user device 308 can, in some embodiments, be a device of a person who recommends or provides building improvements to owners of the buildings 304. The various scores generated by the building target identifier 302 can aid the user of the user device 308 in identifying buildings to recommend improvements to as the score can provide an index for identifying relative opportunity (e.g., relative to other building of a group) to improve the building and/or the health of the building. The building scores can be generated from a group of buildings, e.g., the buildings 304 in a particular geographic area, of a particular building type, a selection of buildings made by a user, etc.

In some embodiments, the building target identifier 302 can be configured to maintain a building score for the buildings 304. The scores can provide a living index, in some embodiments. The building target identifier 302 can receive data from the buildings 304 over time and update and/or adjust the scores for the buildings 304 over time. In some embodiments, after a building improvement is made for a particular building, the building may provide private building data, e.g., utility data, energy usage data, etc. The building target identifier 302 can use the received data to update the score for the building over time. In some implementations, the building target identifier 302 can update the score based on previously implemented recommendations and determine whether the score improved, and/or by what amount the score improved, based on actual collected data after implementation. In some such implementations, the building target identifier 302 may compare the actual achieved score change to a predicted change in score associated with the recommendation.

The building target identifier 302 includes one or more processors 340 and one or more memory devices 342. The processors 340 can be a general purpose or specific purpose processor, an application specific integrated circuit (ASIC), one or more field programmable gate arrays (FPGAs), a group of processing components, or other suitable processing components. The processors 340 may be configured to execute computer code and/or instructions stored in the memories or received from other computer readable media (e.g., CDROM, network storage, a remote server, etc.).

The memory devices 342 can include one or more devices (e.g., memory units, memory devices, storage devices, etc.) for storing data and/or computer code for completing and/or facilitating the various processes described in the present disclosure. The memory devices 342 can include random access memory (RAM), read-only memory (ROM), hard drive storage, temporary storage, non-volatile memory, flash memory, optical memory, or any other suitable memory for storing software objects and/or computer instructions. The memory devices 342 can include database components, object code components, script components, or any other type of information structure for supporting the various activities and information structures described in the present disclosure. The memory devices 342 can be communicably connected to the processors and can include computer code for executing (e.g., by the processors 340) one or more processes described herein.

In some embodiments, the building score generator 318 can be configured to collect data for one specific building or from multiple buildings via the data sources 322-338. The building score generator 318 can analyze the received data for each building and generate a score for each building. The building score generator 318 can analyze one or more various score categories, generate one or more sub-scores, identify one or more parameters, etc. based on the received data. The building score generator 318 can generate a score for each building indicating the potential for making improvements to the building.

In some embodiments, the geographic map data source 322 can provide satellite images, map data, etc. describing the buildings 304 and/or geographic areas of the buildings 304. In some embodiments, the building score generator 318 can derive square footage of the buildings 304 based on satellite images. In some embodiments, the building score generator 318 can generate scores and/or sub-scores for the buildings 304 based on the square footage. In some embodiments, the greater the square footage, the greater the opportunity for improving the building. In some embodiments, the greater the square footage of a rooftop of the building, the greater the opportunity for installing solar panels.

In some embodiments, the satellite images of the buildings 304 can be analyzed by the building score generator 318 to identify what equipment is installed in the building, what equipment is not installed in the building, and what the opportunity for new equipment could be. For example, the satellite images may indicate whether a rooftop unit (RTU) is installed on top of a building, whether the building has unit ventilators or VAVs that can be seen in the satellite images, etc.

In some embodiments, the satellite images can identify how much of the buildings 304 are covered by window glass. The more glass present in the buildings 304, the greater the temperature variance that results from sunlight. The building score generator 318 can identify whether temperature control algorithms that resolve sunlight exposure issues that would be beneficial for a building with a large amount of window glass.

In some embodiments, the building certification data source 324 can provide the building score generator 318 with indications of certifications of the various buildings 304. For example, the building certification data source 324 can be a WELL standard system, a LEEN standard system, and/or any other certification standard system. The building score generator 318 can identify which buildings 304 have certifications and which buildings 304 do not include certifications. If the buildings do not include certifications, this may indicate a greater potential to recommend building improvements to the buildings so that the buildings can meet certain certifications.

In some embodiments, the building information data source 326 can include various pieces of building information. For example, the building information data source 326 can include a building information model (BIM) for a building, indications of equipment installed at the building, square footage of the building, date the building was built, etc.

In some embodiments, the government funding data source 328 can provide indications of government funding available for the buildings 304. For example, various different government subsidies can be available to make improvements to the buildings 304. The building score generator 318 can identify information of the government funding data source 328 that indicates that government funding and/or subsidies are available for specific improvements of the building, indicating that the building has potential for funding. In some embodiments, the building score generator 318 can identify that the building has already claimed and/or used government funding and/or subsidies, indicating that the funding or subsidies are no longer available.

In some embodiments, the geographic environmental data source 330 can provide environmental data for a specific geographic area to the building score generator 318. The environmental data can indicate historical weather trends in geographic areas which the buildings 304 may be located. The weather trends may indicate temperature, humidity, hurricane trends, tornado trends, solar intensity, etc.

The greater the effect of weather, e.g., extreme high or low temperatures, high solar intensity, etc. can indicate a greater potential for building improvements, which can be identified by the building score generator 318. For example, a building in a geographic area that historically has cold winters below freezing may indicate that heating systems require routine maintenance and replacement. However, a building in a temperate climate that does not experience extremely hot temperatures or extremely low temperatures may not require as much temperature conditioning and thus may have a lower potential for building improvements.

In some embodiments, the geographic environmental data source 330 can provide air quality information for various geographic areas, e.g., PM2.5, PM10, volatile organic compound (VOC), allergen levels, etc. The poorer the air quality in the geographic area of the building, the greater the opportunity for installing air quality improvement systems for a building, which can be determined by the building score generator 318. The building score generator 318 can identify the potential for installing air purifying systems in the building.

In some embodiments, the social media data source 332 can provide social media posts and/or publicized information by the buildings 304. The social media posts can include discussions regarding various building improvement opportunities. In some embodiments, the building score generator 318 can identify that a particular entity associated with a building (e.g., a business) is discussing a particular building improvement publically, which may indicate a greater potential to offer the building improvement to the building (the building is more likely to implement the building improvement). Similarly, if one business is discussing a particular building improvement, the building score generator 318 can identify that a competitor business to the one business may also want to make the building improvement.

In some embodiments, the social media posts of a business can be analyzed by the building score generator 318 to identify political opinions of the business. In some embodiments, the building score generator 318 can correlate the political options of the business with the openness of the building to various building improvements, e.g., carbon emissions reduction systems, disease prevention systems, etc.

In some embodiments, the insurance data source 334 can provide insurance data relating to the buildings 304 to the building score generator 318. The insurance data can indicate the insurance plans and/or policies of the various buildings 304. The insurance data can indicate an insurance plan for insuring a particular building, health care plans offered to employees of a business that works at a particular building, etc. The higher the insurance, the more financial assets the entity associated with the building may have. The building score generator 318 can analyze the insurance data to identify which buildings (or entities associated with the buildings) have greater potential to make building improvements, e.g., more financial resources to make building improvements.

In some embodiments, the sensor data source 336 can indicate sensor data for the buildings 304. In some embodiments, the sensor data is infrared sensor data. A technician may be deployed to capture images or data of a building with an infrared sensor to identify how well the building is insulated. The building score generator 318 can identify whether or not a particular building requires an update to insulation in the building based on the infrared sensor data.

In some embodiments, sensor data source 336 could provide sensor data of temporary air quality sensors (e.g., temperature, humidity, PM2.5, PM10, VOC, etc.) installed in the buildings 304. A technician may be deployed to install temporary sensors in the buildings 304 and collect the temporary sensors after a particular period of time. The temporary sensor techniques can be the techniques described in U.S. Provisional Pat. Application No. 63/230,608 filed August 6^{th}, 2021, the entirety of which is incorporated by reference herein. The building score generator 318 can analyze the temporary sensor data to identify potential building improvements for the buildings where temporary air quality sensors have collected sensor data.

In some embodiments, the government permit data source 338 can provide indications of permits acquired for the various buildings 304 from a government agency. The permits can indicate each different improvement, e.g., the installation of equipment, updates to building insulation, updates to windows, etc. The building score generator 318 can identify the potential for a building improvement if the permit data indicates that building equipment was installed long enough ago that it may need to be replaced or serviced. The building score generator 318 can further identify whether the competitor of one business is making certain renovations to their business, indicated by the permits. If a competitor of a business is making a particular improvement, this may indicate that the business may have the desire to make the same improvement.

In some embodiments, the target building identifier 314 can receive the scores generated by the building score generator 318. The various scores for the buildings can be analyzed by the target building identifier 314. The target building identifier 314 can identify which buildings have scores above a particular level. The target building identifier 314 can identify which particular number of buildings have the highest building scores. The identified target buildings can be provided to the user interface manager 316.

In some embodiments, the user interface manager 316 can generate one or more interfaces that indicate the target buildings identified by the target building identifier 314. The one or more interfaces can further indicate the building scores generated by the building score generator 318. The interface can, in some embodiments, include indications of the various facility improvement measures (FIM) to be taken for each building. The various FIMS can be software, hardware, equipment, and/or operating setting improvement measures. In some embodiments, the building target identifier 302 can identify FIMs bases on the systems and method described in U.S. Pat. Application No. 15/456,180 filed March 10^{th}, 2017, the entirety of which is incorporated by reference herein.

In some embodiments, the building operator 312 can be configured to deploy operational settings (e.g., temperature setpoints, air change parameters, air mixture parameters, VAV damper settings, humidity settings, etc.) and/or control algorithms to the building systems 306. In some embodiments, if a building operator makes a purchase and/or agrees for a building improvement to be pushed to their building, the building operator 312 can cause the building systems 306 to update their operation. In some embodiments, the control algorithms can be configured to control heating and/or cooling in a building based on solar radiation. In some embodiments, the control algorithms can operate to reduce carbon emissions, operational costs, and/or energy consumption of building equipment of the building. The building operator 312 may be an optional component of the building target identifier 302, and is thus shown in dashed lines in FIG. 3. In some embodiments, the building operator 312 executes a control algorithm on the building target identifier 302 and decisions, operating parameters, signals, values, of the control algorithm are transmitted, pushed, or deployed to the building systems 306 to cause the building systems 306 to control environmental conditions of the building 304.

In some embodiments, the scoring rules updater 320 can update one or more scoring rules and/or parameters of the building score generator 318. The one or more rules and/or parameters updated scoring updater 320 can adjust the manner in which the building score generator 318 weighs and/or scores the various factors that it uses to generate targeting scores for the building. In some embodiments, the scoring updater 320 uses improvement feedback data indicating whether the buildings accepted and/or rejected various building improvement recommendations. One or more artificial intelligence and/or machine learning techniques can be implemented by the scoring updater 320 to analyze the improvement feedback data 310 and make adjustments that cause the scoring performed by the building score generator 318 to target buildings that will agree to building improvements. In some embodiments, the scoring updater 320 can adjust and/or identify score ranges for various parameters, e.g., a solar irradiance parameter could have a score from a minimum value to a maximum value. The minimum and maximum values can be identified by the scoring updater 320.

In some embodiments, if a building entity approves a particular building improvement recommended by the building target identifier 302 through the user interface manager 316, the user device 308, and/or a representative of the building target identifier 302, the building target identifier 302 can generate one or more work orders for implementing the improvement, apply for one or more building permits, etc. The work orders generated by the user interface manager 316 can be pushed to a user device of a technician (e.g., the user device 308) causing the technician to be deployed to the appropriate building with the appropriate construction materials, equipment, tools, etc.

In some embodiments, the building score generator 318 can generate a score for a building 304 based on third party data collected about the building (e.g., data received from the data sources 322-338) and from data received from building systems 306 of the building (e.g., operational data). For example, the building score generator 318 can receive sensor data from sensors of the building systems 306, fault data from the building systems 306, runtime data, control decision data, event data, timeseries data, or any other type of data. The building score generator 318 can identify whether a piece of building equipment requires maintenance or replacement based on the data for the piece of building equipment, e.g., fault data, timeseries data, sensor measurements, feedback data, control decision data, runtime data, or any other piece of information received for or from the piece of building equipment. The building score generator 318 can generate the score for the building based on whether pieces of equipment of the building 304 require maintenance or replacement. The building score generator 318 can receive indications of what pieces of building equipment are installed in the building 304 from the building systems 306, e.g., the type, age, stock keeping unit (SKU) number, etc. The building score generator 318 can, for example, identify that a piece of equipment has been installed in the building 304 longer than a particular length of time (e.g., a decade, two decades, etc.) and generate a score of the building 304 based on a determination that the piece of building equipment needs to be replaced (e.g., the piece of building equipment has been installed in the building longer than a particular length of time). The building systems 306 can provide indications of the control algorithms or software versions run on the various building systems 306. The building score generator 318 can generate the score for the building 304 based on an indication that software updates are needed for the building systems 306 or improved control algorithms could be run on the building systems 306 to improve performance of the building 304.

Referring now to FIG. 4, a user interface 400 of a city indicating building targeting scores for buildings of the city is shown, according to an exemplary embodiment. The user interface 400 can be a user interface generated by the user interface manager 316 and displayed on the user device 308. In some embodiments, the user interface 400 can include an indication of buildings in a particular geographic region, e.g., the buildings 304. The user interface manager 316 can overlay one or more targeting scores for one, multiple, or all of the buildings shown in the user interface 400. In some embodiments, a user, via their user device, can navigate around the city via control inputs, e.g., swiping, clicking, typing commands, etc. to view different buildings and their targeting scores.

In some embodiments, the user interface manager 316 can overlay the scores on various buildings of a mapping system. For example, various first party or third party mapping or other location-based interfaces can be integrated with the scoring data of the building target identifier 302. Therefore, the user interface manager 316 can cause various satellite and/or computer generated geographic building maps of the various mapping systems integrated with the building scores generated by the building score generator 318.

Scoring parameters of various pieces of data can be used to generate a targeting score for a building shown in FIG. 4. The building score generator 318 can receive parameters from various public and/or private data sources, e.g., the data sources 322-338. The various pieces of data can each fit into a specific category, e.g., an air quality index (AQI) category, a customer equipment category, a solar intensity category, etc. In some embodiments, the building score generator 318 can generate a score for each category indicting the potential for improvements for the building in each category. The score of each category can be aggregated into an aggregate score by the building score generator 318, indicating a total score indicating the likelihood that the building will accept recommendations for building improvements and/or the total potential for improvements to the building.

The AQI can indicate air quality in a geographic area that the building is located. The lower the AQI, the higher the score. A low AQI may indicate that the building is experiencing air quality issues and/or the building needs equipment to properly control air quality within their building due to the adverse outdoor air quality in the area that the building is located. The building score generator 318 can be configure to generate a score for the AQI category based on the AQI for the geographic area that the building is located.

The building equipment category can indicate a catalog of building equipment currently installed at the building. The catalog can indicate the types of equipment, the brand of equipment, the age of the equipment, etc. The building score generator 318 can generate a higher score if more of the building equipment installed in the building could be replaced and/or retrofitted. The building score generator 318 can generate a lower score if more of the building equipment installed in the building is new, is designed and/or manufactured by a trusted brand, etc. In some embodiments, if the equipment is outdated and/or is using old technologies, the building score generator 318 can generate a higher score for the building equipment category.

The solar intensity category can indicate a solar intensity for a building. The solar intensity can be received by the building target identifier 302 from a data source. In some embodiments, the solar intensity can be calculated by the building target identifier 302 based on solar intensity levels of a geographic area that the building is located, based on a square footage of the building, based on a number of floors of the building, based on an outside surface area of the building, etc.

The area category can indicate the square footage of the particular building. The greater the square footage, the higher the building score generator 318 can set the score for the area category. The greater the square footage the larger in size of various building improvements. For example, for a larger building, more AHUs would be needed for a conversion from a unit ventilator system to a AHU/VAV based system.

The year built category can indicate the date or year that the building was built. The older the building, the higher the year built category score can be determined by the building score generator 318. If a building is new, it is unlikely to require significant improvements, equipment retrofits, equipment replacements, etc. However, if a building is old, it has a greater potential for building retrofitting and/or improvement.

The main competitor permits category can indicate which competitors to the building are currently making improvements to their building. The category can further indicate what building improvements the competitor is making. If competitors of the building are making improvements to their buildings, this may indicate that the owner of the building would also like to make improvements to their building in order to keep their facility modern relative to their competitors. The more competitors making building improvements and the larger in scale the improvements, the higher the building score generator 318 can generate the main competitor permit category score.

The building certificate category can indicate certifications for the building. The certifications can indicate whether the building has a WELL certification, a LEED certification, etc. Furthermore, the level of certification can be indicated in the building certificate category. The more certifications held by the building (or the higher the certification level) can indicate that the building is performing well and does not need any significant building improvements. However, if the building does not hold many certifications or has certification levels that are low, this may indicate that the building has a greater need for building improvements. The building score generator 318 can generate the score based on the certifications and/or levels of the certifications for the buildings.

The stimulus funding can indicate whether stimulus funding is available for the building that could be used to make building improvements. For example, stimulus funding may be available for certain geographic areas (e.g., certain cities, counties, states, countries, etc.), whether stimulus funding is available for certain business verticals (e.g., health care, apartment complexes, universities, etc.). The stimulus funding could be Elementary and Secondary School Emergency Relief (ESSER) funding. The greater the amount of stimulus funding available for a building, the higher the building score generator 318 can set the stimulus funding category score.

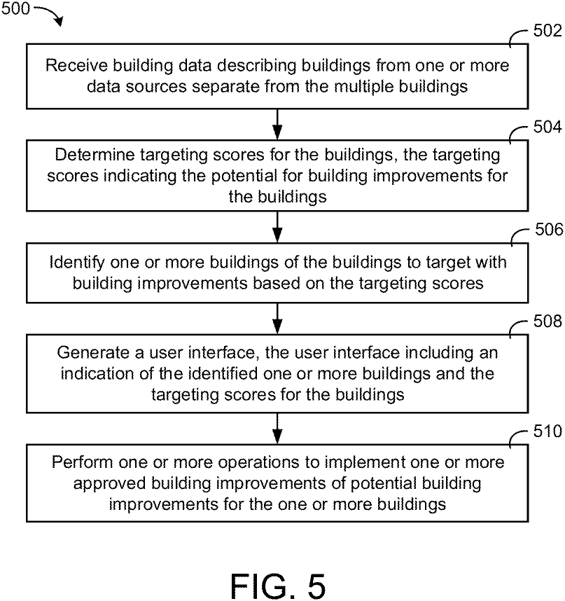

Referring now to FIG. 5, a process 500 of generate targeting scores indicating potentials for implementing building improvements for various buildings is shown, according to an exemplary embodiment. In some embodiments, the building target identifier 302 can be configured to perform the process 500. Furthermore, any system, building system, apparatus, or computing device described herein can be configured to perform the process 500.

In step 502, the building target identifier 302 receives building data describing the buildings 304 from data sources other than the buildings 304. The data sources can be government data sources, public data sources, satellite imagery, geographic weather related data, public insurance data, permit data, certification data, etc. The data sources can be operated by entities separate from an entity associated with the building. The data sources may be the data sources 322-336.

In step 504, the building target identifier 302 can determine targeting scores for the buildings, the targeting scores can indicate a potential for improving the buildings 304. The score can indicate a level that indicates the potential for improving the buildings 304. The potential improvements can indicate building improvements that are available to be made for the building. The score can relate the amount and/or size of the potential improvements for the building, e.g., the number of improvements, the size of the jobs for implementing the improvements, the financial return for the improvements, etc. The building target identifier 302 can generate sub-scores in various categories and then aggregate the sub-scores into an aggregate target score.

In step 506, the building target identifier 302 identifies one or more buildings of the building to target with building improvements based on the targeting scores. The building target identifier 302 can select buildings associated with the highest building scores (e.g., associated with the greatest opportunity for building improvements). In some embodiments, the building target identifier 302 can select buildings associated with building scores greater than a particular level. The building target identifier 302 can select a single building or multiple buildings to target with an improvement recommendation. For example, if two buildings 304 each include a score above a threshold, e.g., a predetermined or dynamically determined value, the building target identifier 302 can select each of the two buildings 304 to generate a recommendation for.

In step 508, the building target identifier 302 can generate a user interface that includes indications of the buildings selected in the step 506. The user interface can further indicate the targeting scores for the buildings. In some embodiments, the user interface can indicate the building improvements that could be implemented to improve performance of the various buildings. The user interface can be a table identifying each building 304 and the scores or sub-scores for each building 304. The user interface may only include the buildings 304 that are selected and exclude buildings 304 that the target identifier 302 did not select. The user interface can be a report, a spreadsheet, a mobile application notification, a graphical user interface, or any other interface. The user interface can be a three or two dimensional map identifying each building 304 and the score for each building 304.

In step 510, the building target identifier 302 can optionally implement one or more operations to implement approved building improvements of the potential improvements presented in the user interface in step 508. In some embodiments, a building entity associated with the building can approve a recommended improvement for their building 304. The improvement can be a control algorithm and/or settings adjustment for the building. The building target identifier 302 can deploy the algorithm and/or settings adjustment to equipment of the building via a network. In some embodiments, the improvement is an equipment installation and/or building construction improvement. The building target identifier 302 can be configured to generate a work order for a technician and/or construction team causing the technician and/or construction team to implement the equipment installation and/or building construction. In some embodiments, the one or more operations include selecting buildings to perform an analysis on and/or performing, by the building target identifier 302, an analysis on one or more selected buildings (e.g., the buildings identified in the step 506). The analysis may include identifying one or more specific building improvements for the buildings, identifying operational updates for the one or more buildings, identify cost reductions resulting for the one or more building improvements, identifying energy consumption reduction resulting from the one or more improvements, etc. While some implementations may be configured to implement one or more of the operations to effect the building improvements, it should be understood that some embodiments of the present disclosure may identify targeting scores but not potential improvements or implement operations to effectuate the improvements, and some embodiments may identify targeting scores and potential improvements but may not automatically implement operations to effectuate the improvements. For example, some implementations may determine targeting scores to identify improvement opportunities, and provide the scores for manual action by a user of the system. Other implementations may determine targeting scores and automatically generate some suggested potential improvements/recommendations and may provide the improvements/recommendations to a user for manual action. All such modifications are contemplated within the scope of the present disclosure.

In some embodiments, a system including one or more memory devices storing instructions thereon that, when executed by one or more processors, cause the one or more processors to receive building data for buildings from one or more data sources, wherein at least one building of the buildings includes building equipment that operates to execute a control algorithm to control an environmental condition of the building, generate scores based on the building data for the buildings, the scores indicating a level of potential building improvements for the buildings, and select the building of the buildings based at least in part on the scores.

In some embodiments, the system can perform at least one operation. The operation can be a computer implemented process, set of instructions, computer executable code, or other action. The operation can generate data. The operation can generate data to improve control of the environmental condition of the building. The operation can include generating a control decision, control setting, control action, or other operation that updates, modifies, changes, or controls the operation of equipment of the building. The data can cause the equipment to change control of the environmental conditions of the building. The operation can generate data to cause a display device to display a graphical user interface that includes recommendations for making improvements to the building, e.g., installing new equipment, performing building renovations, updating control software of existing pieces of equipment, etc. A user can review the improvements or recommendations and take actions to improve the building. For example, the user can accept recommendations via the graphical user interface to allow the system to automatically implement the recommendations (e.g., automatically update control settings, generate work orders, etc.). The operation can generate data including work order data. The operation can generate work order data that defines a work order for a maintenance or installation individual to perform. The work order can indicate to perform maintenance on a particular piece of equipment, replace an existing piece of equipment, install new equipment, etc. The operation can generate data that causes the work order to be added to a work order scheduling system that schedules work orders and assigns personal to the work orders.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, calculation steps, processing steps, comparison steps, and decision steps.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

What is claimed:

1. A system comprising one or more memory devices storing instructions thereon that, when executed by one or more processors, cause the one or more processors to:
receive building data for a plurality of buildings from one or more data sources, wherein at least one building of the plurality of buildings includes building equipment that operates to execute a control algorithm to control an environmental condition of the building;
generate a plurality of scores based on the building data for the plurality of buildings, the plurality of scores indicating a level of potential building improvements for the plurality of buildings;
select the building of the plurality of buildings based at least in part on the plurality of scores; and
perform an operation based at least in part on the score to generate data to improve control of the environmental condition of the building.

2. The system of claim 1, wherein the instructions cause the one or more processors to:
perform the operation to deploy at least one of operating settings to the building equipment of the building to cause the control algorithm to control the environmental condition of the building based on the operating setting.

3. The system of claim 1, wherein the one or data sources include one or more third party databases managed by an entity other than an entity associated with the building.

4. The system of claim 1, wherein the instructions cause the one or more processors to:
perform the operation by generating a work order for implementing the building improvement for the building.

5. The system of claim 1, wherein the building data is public data describing the plurality of buildings or describing conditions associated with the plurality of buildings.

6. The system of claim 1, wherein the building data includes image data of the plurality of buildings captured by at least one satellite;
wherein the instructions cause the one or more processors to derive one or more factors describing the plurality of buildings from the image data.

7. The system of claim 1, wherein the building data is sensor data collected from a plurality of temporary sensors installed in the plurality of buildings at a time and uninstalled from the plurality of buildings after a period of time passes from the time.

8. The system of claim 1, wherein the instructions cause the one or more processors to: generate the plurality of scores based on the building data and scoring rules;
receive feedback data indicating one or more first building improvements approved by an entity of the building and one or more second building improvements rejected by the entity; and
perform a machine learning algorithm on the feedback data to identify one or more updates for the scoring rules.

9. The system of claim 1, wherein the instructions cause the one or more processors to:
generate a user interface including the plurality of scores, indications of the plurality of buildings, and indications of potential building improvements for the plurality of buildings; and
cause a display device of a user device to display the user interface.

10. The system of claim 1, wherein the instructions cause the one or more processors to:
generate data to cause a user device to display a user interface to include a map of a geographic area including the plurality of buildings;
wherein the user interface includes an indication for the plurality of buildings in the map of the geographic area indicating the score for the plurality of buildings.

11. The system of claim 1, wherein the instructions cause the one or more processors to:
generate the score of the plurality of scores for the building of the plurality of buildings by:
generating a plurality of sub-scores of a plurality of categories based on the building data; and
aggregating the plurality of sub-scores into the score.

12. The system of claim 11, wherein the plurality of sub-scores are based on data elements including:
an air quality index (AQI) indicating an air quality in a geographic area of the building;
indications of building equipment installed in the building;
a solar intensity associated with the building;
a square footage of the building;
a year that the building was built;
an indication of work permits implemented at a second building owned by a competitor of the building;
an indication of one or more certifications of the building; or
an indication of an availability of stimulus funding for the building.

13. A method comprising:
receiving, by one or more processing circuits, building data for a plurality of buildings from one or more data sources, wherein at least one building of the plurality of buildings includes building equipment that operates to execute a control algorithm to control an environmental condition of the building;
generating, by the one or more processing circuits, a plurality of scores based on the building data for the plurality of buildings, the plurality of scores indicating a level of potential building improvements for the plurality of buildings;
selecting, by the one or more processing circuits, the building of the plurality of buildings based at least in part on the plurality of scores; and
performing, by the one or more processing circuits, an operation based at least in part on the score to generate data to improve control of the environmental condition of the building.

14. The method of claim 13, comprising:
performing, by the one or more processing circuits, the operation to deploy at least one of operating settings to the building equipment of the building to cause the control algorithm to control the environmental condition of the building based on the operating setting.

15. The method of claim 13, wherein the building data includes image data of the plurality of buildings captured by at least one satellite;
the method comprising:
deriving, by the one or more processing circuits, one or more factors describing the plurality of buildings from the image data.

16. The method of claim 13, wherein the building data is sensor data collected from a plurality of temporary sensors installed in the plurality of buildings at a time and uninstalled from the plurality of buildings after a period of time passes from the time.

17. The method of claim 13, comprising:
generating, by the one or more processing circuits, the plurality of scores based on the building data and scoring rules;
receiving, by the one or more processing circuits, feedback data indicating one or more first building improvements approved by an entity of the building and one or more second building improvements rejected by the entity; and
performing, by the one or more processing circuits, a machine learning algorithm on the feedback data to identify one or more updates for the scoring rules.

18. The method of claim 13, comprising:
generating, by the one or more processing circuits, a user interface including the plurality of scores, indications of the plurality of buildings, and indications of potential building improvements for the plurality of buildings; and
causing, by the one or more processing circuits, a display device of a user device to display the user interface.

19. One or more computer readable medium storing instructions thereon that, when executed by one or more processors, cause the one or more processors to:
receive building data for a plurality of buildings from one or more data sources, wherein at least one building of the plurality of buildings includes building equipment that operates to execute a control algorithm to control an environmental condition of the building;
generate a plurality of scores based on the building data for the plurality of buildings, the plurality of scores indicating a level of potential building improvements for the plurality of buildings;
select the building of the plurality of buildings based at least in part on the plurality of scores; and
perform an operation based at least in part on the score to generate data to improve control of the environmental condition of the building.

20. The one or more computer readable medium of claim 19, wherein the instructions cause the one or more processors to:
perform the operation to deploy at least one of operating settings to the building equipment of the building to cause the control algorithm to control the environmental condition of the building based on the operating setting.
